(19) United States
(12) Patent Application Publication
(10) Pub. No.: US 2026/0252376 A1
(43) Pub. Date: Aug. 27, 2026

(54) BLOCKCHAIN SYSTEM INCLUDING TRANSACTION CLASSIFYING NETWORK

(71) Applicant: LSware Inc., Seoul (KR)

(72) Inventors: Min Soo KIM, Seongnam-si (KR); Dong Myung SHIN, Seoul (KR); Yong Joon JOE, Seoul (KR); Chang Hyun ROH, Seoul (KR)

(73) Assignee: LSware Inc., Seoul (KR)

(21) Appl. No.: 19/063,404

(22) Filed: Feb. 26, 2025

(30) Foreign Application Priority Data
Feb. 26, 2025 (KR) 10-2025-0024833

(51) Int. Cl. G06F 9/46; H04L 9/00

(52) U.S. Cl. CPC G06F 9/466; H04L 9/50

(57) ABSTRACT

The present disclosure relates to a blockchain system including a transaction classifying network, wherein the blockchain system includes a blockchain network including a first blockchain and a second blockchain and a transaction classifying network which classifies a plurality of transaction proposals transmitted from clients to transmit the transaction proposals to the blockchain network.

### CROSS-REFERENCE TO RELATED APPLICATIONS

This application claims the priority of Korean Patent Application No. 10-2025-0024833 filed on Feb 26, 2025, in the Korean Intellectual Property Office, the disclosure of which is incorporated herein by reference.

### BACKGROUND

The present disclosure relates to a blockchain system including a transaction classifying network which effectively classifies various types of transactions transmitted from clients and a transaction classifying method using the same.

Recently, the frequency of utilizing a blockchain to process and store data generated in various fields has increased so that the number of transaction proposals to be processed has rapidly increased.

As the improvement of the performance of blockchain nodes does not directly lead to the improvement in the processing speed of the transaction proposals, many studies have been conducted recently to improve a transaction processing speed through a structure, such as Layer-2.

However, some Layer-2 solutions have a relatively centralized structure, which is contrary to the inherent advantage of the blockchain, which is decentralization, so that there is a problem in that it affects the security and reliability of the network.

Accordingly, a method for efficiently processing various types of transactions while maintaining the existing blockchain architecture is necessary.

### Prior Art

### Patent Document

Korean Unexamined Patent Application Publication No. 10-2021-0061240

### SUMMARY

The present disclosure has been made to solve the above-described problem and an object is to provide a blockchain system which efficiently classifies various types of transactions to improve a transaction processing speed and a transaction classifying method using the same.

However, the object to be achieved by the present disclosure is not limited to the above-described object and objects which have not been mentioned will be apparently understood to those skilled in the art from the specification and the accompanying drawings.

In order to achieve the above-described object, a blockchain system including a transaction classifying network of the present disclosure includes a blockchain network including a first blockchain and a second blockchain; and a transaction classifying network which classifies a plurality of transaction proposals transmitted from clients to transmit the transaction proposals to the blockchain network.

The first blockchain includes a plurality of first nodes, the second blockchain includes a plurality of second nodes, and the transaction classifying network includes the first node and the second node.

The transaction classifying network includes a first storage and a second storage to which a transmitted transaction proposal is transmitted, the first transaction classifying network includes a first transaction classifying unit, and the first transaction classifying unit classifies a transaction proposal located in the first storage to transmit the transaction proposal to a first transaction batch and the second storage.

The transaction classifying network further includes a second transaction classifying unit, and the second transaction classifying unit classifies a transaction proposal located in the second storage to transmit the transaction proposal to a second transaction batch.

The first blockchain may include a plurality of first nodes, the second blockchain may include a plurality of second nodes, and the blockchain network may include a first internode including the first node and the second node.

The transaction classifying network may classify a transaction transmitted from a client into a first transaction batch to be transmitted to a first blockchain network, a second transaction batch to be transmitted to a second blockchain network, and a third transaction batch to be transmitted to an internode.

The transaction classifying network may classify a transaction proposal by dividing a period based on a set condition. The set condition may be a set time and a transaction processing capacity of the transaction batch and the transaction classifying system may classify a transaction proposal which is transmitted until a time when any one condition of the set time and the transaction processing capacity is completed.

According to the exemplary embodiment of the present disclosure, in a blockchain system including a transaction classifying network, the blockchain system includes a plurality of blockchains, various transaction proposals which need to be stored in each blockchain are classified based on a specific criterion without executing a processing result in advance, and are transmitted to a blockchain or an internode which needs to be processed, thereby improving a processing speed for the transaction proposal.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a view illustrating an entire configuration of a blockchain system of an exemplary embodiment of the present disclosure;

FIG. 2 is a view for explaining a concept of a plurality of blockchains and internodes of a blockchain system of an exemplary embodiment of the present disclosure;

FIG. 3 is a view for explaining a concept of a transaction classifying network of a blockchain system of an exemplary embodiment of the present disclosure;

FIG. 4 is a view for explaining configurations of a plurality of transaction batches and blockchains and internodes in a blockchain system of an exemplary embodiment of the present disclosure;

FIG. 5 and FIG. 6 are a view for explaining a process of classifying a transaction and transfering transaction to the Blockchain in a blockchain system of an exemplary embodiment of the present disclosure.

### DETAILED DESCRIPTION OF THE EMBODIMENT

Hereinafter, a specific exemplary embodiment of the present disclosure will be described in detail with reference to drawings. However, the spirit of the present disclosure is not limited to a proposed exemplary embodiment and those skilled in the art who understand the spirit of the present disclosure will be able to easily propose another exemplary embodiment included within the scope of the spirit of other regressive inventions or the present disclosure by adding, changing, or deleting another component within the scope of the same spirit, which is also said to be included within the scope of the invention of the present disclosure.

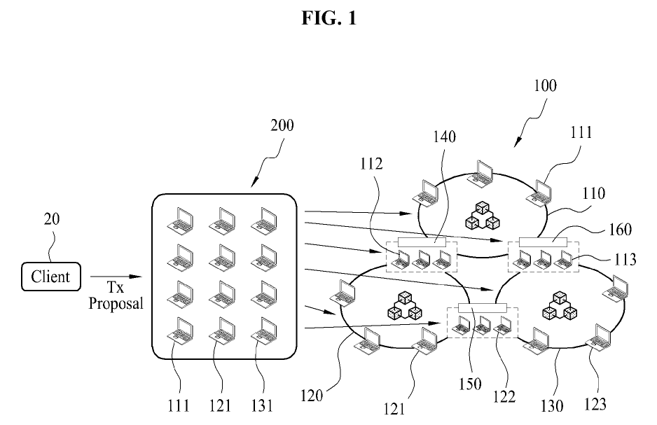

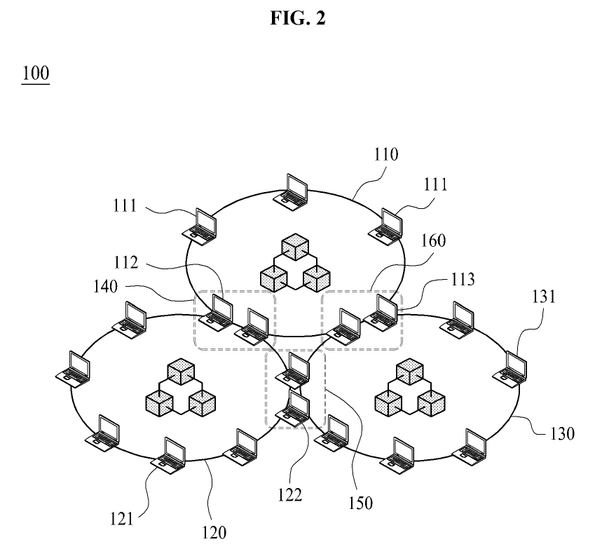

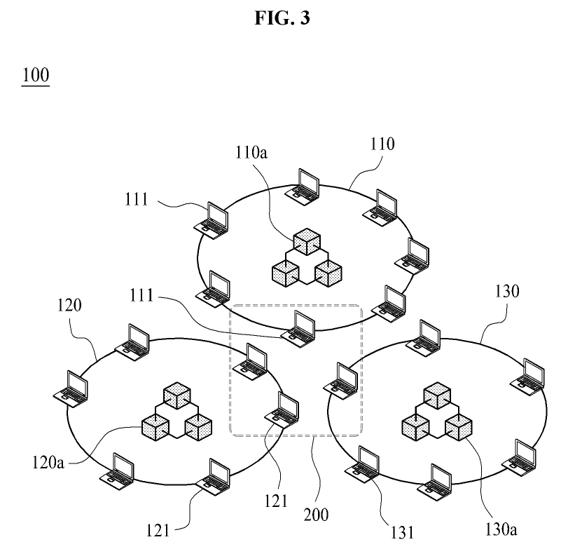

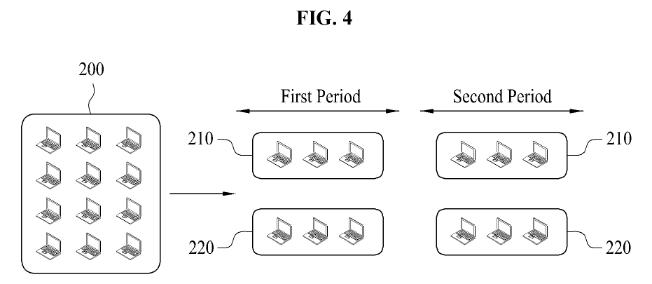

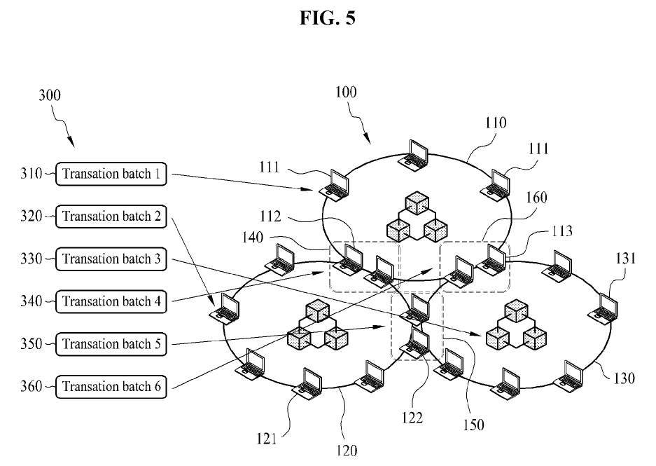

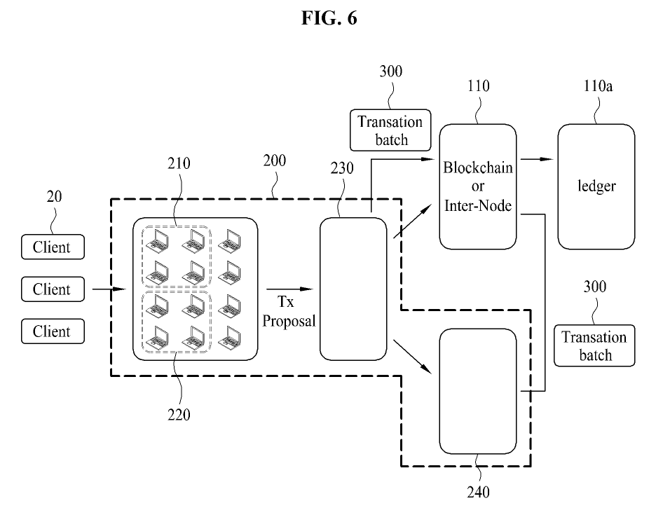

FIG. 1 is a view illustrating an entire configuration of a blockchain system of an exemplary embodiment of the present disclosure, FIG. 2 is a view for explaining a concept of a plurality of blockchains and internodes of a blockchain system of an exemplary embodiment of the present disclosure, FIG. 3 is a view for explaining a concept of a transaction classifying network of a blockchain system of an exemplary embodiment of the present disclosure, FIG. 4 is a view for explaining a main agent of transaction classification for every period in a transaction classifying network of a blockchain system of an exemplary embodiment of the present disclosure, FIG. 5 and FIG. 6 are a view for explaining a process of classifying a transaction and transfering transaction to the Blockchain in a blockchain system of an exemplary embodiment of the present disclosure.

Referring to FIG. 1, the blockchain system 1 of the present exemplary embodiment includes a blockchain network 100 and a transaction classifying network 200. A transaction proposal (Tx proposal) which is transmitted from a client 20 to the transaction classifying network 200 is classified in the transaction classifying network 200 and is transmitted to the blockchain network 100.

Referring to FIG. 2, the blockchain network 100 includes a plurality of blockchains and a plurality of internodes and the exemplary embodiment is described that the blockchain network 100 includes a first blockchain 110, a second blockchain 120, a third blockchain 130, a first internode 140, a second internode 150, and a third internode 160.

The first blockchain 110, the second blockchain 120, and the third blockchain 130 may have different block generation periods and in the exemplary embodiment, it is assumed that the first blockchain 110, the second blockchain 120, and the third blockchain 130 have the same block generation period.

The first blockchain 110, the second blockchain 120, and the third blockchain 130 may reach consensus on the transaction proposals for different types of objects and record the transaction proposals.

In the exemplary embodiment, it is exemplary described that a transaction for dealing real estate, art, and NFT is processed to reach consensus and be recorded in three blockchains. That is, it is assumed that the first blockchain 110 stores transaction parties and transaction history for the real estate, the second blockchain 120 stores transaction parties and transaction history for the art, and the third blockchain 130 stores transaction parties and transaction history for the NFT.

Each blockchain includes a plurality of nodes for processing the transaction proposal to be transmitted. Some of the plurality of nodes have one blockchain ledger and the other includes a plurality of blockchain ledgers.

Specifically, in the present exemplary embodiment, the first blockchain 110 includes a first node 111, a second node 112, and a third node 113.

The first node 111 has a ledger 110a of the first blockchain 110, the second node 112 has a ledger 110a of the first blockchain 110 and a ledger 120a of the second blockchain 120, and the third node 113 has a ledger 110a of the first blockchain 110 and a ledger 130a of the third blockchain 130.

The second blockchain 120 includes a fourth node 121, a fifth node 122, and the second node 112.

The fourth node 121 has a ledger 120a of the second blockchain 120, the fifth node 122 has a ledger 120a of the second blockchain 120 and a ledger 130a of the third blockchain 130, and the second node 112 has a ledger 110a of the first blockchain 110 and a ledger 120a of the second blockchain 120.

The third blockchain 130 includes a seventh node 131, the third node 113, and the fifth node 122.

The seventh node 131 has a ledger 130a of the third blockchain 130, the third node 113 has a ledger 110a of the first blockchain 110 and a ledger 130a of the third blockchain 130, and the fifth node 122 has a ledger 130a of the third blockchain 130 and a ledger 120a of the second blockchain 120.

The first internode 140 is configured by the second nodes 112, the second internode 150 is configured by the third nodes 113, and the third internode 160 is configured by the fifth nodes 122.

That is, the second nodes 112 belonging to the first internode 140 have a ledger 110a of the first blockchain for the real estate and a ledger 120a of the second blockchain for the art.

The third nodes 113 belonging to the second internode 150 have a ledger 110a of the first blockchain for the real estate and a ledger 130a of the third blockchain for the NFT. The fifth nodes 122 belonging to the third internode 160 have a ledger 120a of the second blockchain for the art and the ledger 130a of the third blockchain for the NFT.

That is, each blockchain and internode reach consensus on the transaction proposal having information to be recorded in a ledger held by nodes belonging thereto. Specifically, in the exemplary embodiment, a transaction proposal including information about real estate transaction is transmitted to the first blockchain 110, a transaction proposal including information about art transaction is transmitted to the second blockchain 120, and a transaction proposal including information about NFT transaction is transmitted to the third blockchain 130 to be processed.

A transaction proposal including information about transactions of real estate and art is processed in the first internode 140, a transaction proposal including information about transactions of art and NFT is processed in the second internode 150, and a transaction proposal including information about transactions of NFT and real estate is processed in the third internode 160.

Further, in each internode, a transaction including a transaction between different assets can be processed. For example, in the first internode 140, direct transaction for the real estate and art is possible. Accordingly, the blockchain system having transaction information about different assets may reach consensus on and record a transaction proposal including a transaction such as exchange between assets belonging to each system.

That is, direct transaction between assets without using money, such as dollars, as a medium is possible between transaction parties so that a new platform which induces the transaction between different assets by connecting a transaction platform using a blockchain for various types of assets may be implemented.

Referring to FIGS. 3 to 6, the transaction classifying network 200 classifies a plurality of transaction proposals transmitted from the client 20 to transmit the plurality of transaction proposals to the blockchain network 100. Specifically, the transaction proposals are classified based on a common key and a transaction batch is transmitted to the corresponding blockchain or internode to be processed without performing validation to improve a transaction proposal processing speed.

The transaction classifying network 200 is configured by nodes dispatched from each blockchain. Specifically, in the exemplary embodiment, the transaction classifying network is configured by a first node 111 dispatched from the first blockchain 110, a second node 121 dispatched from the second blockchain 120, and a third node 131 dispatched from the third blockchain 130. As each node 111, 121, 131 dispatched from each blockchain participates in the classification, the reliability of classifying transactions may be improved.

The transaction classifying network 200 includes a plurality of transaction classifying units and in the exemplary embodiment, includes a first transaction classifying unit 210 and a second transaction classifying unit 220.

Each transaction classifying unit 210 is configured by some of the plurality of nodes belonging to the transaction classifying network 200 and classifies transaction proposals transmitted to the transaction classifying network 200.

The transaction classifying network 200 includes a plurality of storages to store a transaction proposal which is transmitted in each period and in the exemplary embodiment, includes a first storage 230 and a second storage 240.

In the first storage 230, a transaction proposal transmitted to the transaction classifying network 200 is stored and the first transaction classifying unit 210 classifies the transaction proposal located in the first storage 230 based on the common key.

In the second storage 240, a transaction proposal which is not classified in the first storage 230 is stored and the second transaction classifying unit 220 classifies the transaction proposal located in the second storage 240 based on the common key.

The classified transaction proposal is transmitted to the transaction batch 300 and is transmitted to the blockchain or the internode to be processed in the unit of transaction batch 300.

The transaction batch 300 in the present disclosure includes six transaction batches 310, 320, 330, 340, 350, and 360 which are transmitted to three blockchains 110, 120, and 130 and three internodes 140, 150, and 160. A transaction proposal which needs to be processed in each blockchain or internode is classified to be transmitted to each transaction batch.

The transaction classifying network 200 performs a classifying task by dividing transaction proposals which are continuously transmitted. A criterion for division may be a time or a processing capacity of the transaction batch 300 to be described below.

The period may be defined as a specific time and for example, may be a generation period of the blockchains 110, 120, and 130, but is not limited thereto.

In the present disclosure, the transaction proposal may be divided based on a condition which is first achieved, between two conditions of the period and the processing capacity of the transaction batch 300. Specifically, the transaction proposal which is transmitted until a specific time is reached is classified. If a processing capacity of the transaction batch 300 is reached, a transaction proposal which is transmitted thereafter may be classified in a subsequent section.

In the following description, the section which divides the transaction proposal is defined as a first period and a second period.

That is, if any one condition between a time defined as the first period or a processing capacity of the transaction batch is achieved for a transaction proposal which is transmitted in the first period, a transaction proposal which is transmitted thereafter is separated from the transaction proposal which is transmitted in the first period which is separated from the second period to be classified.

A processing capacity of the transaction proposal which is disposed and processed in the transaction batch 300 may be set based on a processing capacity of each of the plurality of transaction batches. For example, as in the exemplary embodiment, six transaction batches 310, 320, 330, 340, 350, and 360 have a processing capacity of a transaction proposal which is processible in each transaction batch. A processing capacity of a transaction proposal which is processible in each transaction batch may be determined by a performance of nodes belonging to a blockchain or internodes to which each transaction batch is transmitted to be processed.

Specifically, a transaction proposal is transmitted to the transaction classifying network 200 for a specific time (for example, 10 minutes) and a transmitted transaction proposal is classified based on the common key to be transmitted to any one of six transaction batches. The transaction proposal which is not classified based on the common key is transmitted to the second storage 240.

The transaction proposal which is transmitted to the second storage 240 is classified to a new transaction batch 300 through the second transaction classifying unit 220 to be transmitted to the blockchain or the internode to be processed.

If a processing capacity of each transaction batch is not reached, a classifying task for the transaction proposal to be transmitted for a time which defines the first period continues and if a transaction proposal corresponding to the processing capacity is transmitted to six transaction batches, the first period ends and the second period starts.

When the second period is in progress, as described for the first period, the transaction proposal to be transmitted is transmitted to the first storage 230 and the transmitted transaction proposal is classified in the first transaction classifying unit 210 to be disposed in the transaction batch 300 and transmitted to the blockchain or the internode to be processed.

The transaction proposal which is not classified to the transaction batch in the first storage 230 is transmitted to the second storage 240 to be classified by the second transaction classifying unit 220 to be transmitted to a new transaction batch.

As described above, in the present disclosure, the transaction proposals which are continuously transmitted are separated by dividing the period to be classified and processed, thereby improving the processing speed of the entire transaction proposal. Moreover, the transaction proposals which are classified based on the common key are collectively processed by means of the transaction batch to solve the conflict problem according to the parallel processing of the transaction proposal.

Hereinafter, a process of classifying a transaction proposal in a blockchain system including a transaction classifying network of the present disclosure will be described.

As the first period starts, the plurality of transaction proposals is transmitted to the transaction classifying network 200 and is located in the first storage 230.

In the first storage 230, the first transaction classifying unit 210 classifies the transaction proposal based on the common key and transmits the transaction proposal to the corresponding transaction batch 300.

For example, if the transaction proposal is related to real estate, the transaction proposal is transmitted to the first transaction batch 310, if the transaction proposal is related to the art, the transaction proposal is transmitted to the second transaction batch 320, and if the transaction proposal is related to NFT, the transaction proposal is transmitted to the third transaction batch 330.

Further, if the transaction proposal is related to real estate and art, the transaction proposal is classified to the fourth transaction batch 340, if the transaction proposal is related to art and NFT, the transaction proposal is classified to the fifth transaction batch 350, and if the transaction proposal is related to NFT and real estate, the transaction proposal is classified to the sixth transaction batch 360.

If the processing capacity of the first to sixth transaction batches is not fully occupied, the transaction proposal is consistently received and classified by a set time (for example, 10 minutes). Even though the set time has not elapsed, if the processing capacity of the first to sixth transaction batches is full, the first period ends and the second period starts and the process of receiving and classifying the transaction proposal in the first storage 230 again is repeated.

In the meantime, the first to sixth transaction batches in which the transaction proposals classified in the first period are disposed are transmitted to each blockchain 110, 120, 130 and the internode 140, 150, 160 to be recorded in the ledger through the consensus process.

The transaction proposal which is not classified in the first period, but is transmitted to the second storage 240 is classified by the second transaction classifying unit 220 in the second storage 240 while the second period is in progress and is classified to a new transaction batch 300 and then is transmitted to each blockchain 110, 120, 130 and internode 140, 150, 160 to be recorded in the ledger through the consensus process.

Here, an example of the transaction proposal and a process of extracting a common key therethrough will be described.

In this specification, the term “common key” refers to a data key that is accessed or subject to create, modify, or delete operations by two or more transactions (including transaction proposals) simultaneously. Such a common key is a primary source of conflicts during the Multi-Version Concurrency Control (MVCC) process for managing concurrent transactions. When different transactions attempt to access the same common key, read and write operations for that key must be properly coordinated and managed. Through this mechanism, data consistency and integrity can be maintained in transactions that involve a common key. Therefore, effective management of common keys in a blockchain system ensures safe and accurate concurrent processing of multiple transactions.

As described above, if information about transaction of real estate is recorded in the first blockchain 110 and the first blockchain 110 is defined as X, a transaction proposal to be stored including a content that A transfers 50 tokens of a real estate α to B may be defined as transfer X (A, B, α, 50). A key of the corresponding proposal may be extracted as X-A-α and X-B-α based thereon.

If the specific transaction proposal has the same key as any one of X-A-α and X-B-α, the transaction proposal is classified to the same transaction batch to be transmitted to the first blockchain 110 to be processed.

For example, a transaction proposal with a content that A transfers 20 tokens of a real estate α to C is defined as transfer X (A, C, α, 20) and keys of X-A-α and X-C-α are extracted. Further, the transaction proposal has the common key X-A-α with the above transaction proposal. Therefore, the transaction proposal is disposed in the first transaction batch 310 in which the transaction proposal which needs to be processed in the first blockchain 110 is disposed to be transmitted to the first blockchain 110 and continues a process of reaching consensus and being recorded in a ledger.

That is, in the present disclosure, in a blockchain system including a plurality of blockchain networks, various transaction proposals which need to be stored in each blockchain are classified based on a common key without executing a processing result in advance and the classified transaction proposal is transmitted to the blockchain or the internode through one transaction batch to reach the consensus. Therefore, a time for the consensus (block confirmation) may be shortened and the conflict between the transaction proposals which are processed in parallel during the parallel processing process of the transaction proposals may be suppressed. Consequently, the processing speed of the transaction proposal may be improved.

Moreover, an integrated blockchain system including a plurality of blockchains based on different objects is constructed to effectively classify and process transaction proposals with various transaction conditions.

Although in the above description, a configuration and a feature of the present disclosure have been described with respect to the exemplary embodiment of the present disclosure, the present disclosure is not limited thereto and it is obvious to those skilled in the art that various changes or modification can be made within the spirit and the scope of the present disclosure, so that such changes or modifications fall within the scope of the appended claims.

What is claimed is:

1. A blockchain system, comprising:
a blockchain network including a first blockchain and a second blockchain; and
a transaction classifying network which classifies a plurality of transaction proposals transmitted from clients to transmit the transaction proposals to the blockchain network.

2. The blockchain system according to claim 1, wherein the first blockchain includes a plurality of first nodes, the second blockchain includes a plurality of second nodes, and the transaction classifying network includes the first node and the second node.

3. The blockchain system according to claim 1, wherein the transaction classifying network includes a first storage and a second storage to which the transmitted transaction proposal is transmitted,
the transaction classifying network includes a first transaction classifying unit, and
the first transaction classifying unit classifies the transaction proposal located in the first storage to transmit the transaction proposal to a first transaction batch and the second storage.

4. The blockchain system according to claim 2, wherein the transaction classifying network further includes a second transaction classifying unit, and
the second transaction classifying unit classifies the transaction proposal located in the second storage to transmit the transaction proposal to a second transaction batch.

5. The blockchain system according to claim 1, wherein the first blockchain includes a plurality of first nodes, the second blockchain includes a plurality of second nodes, and the blockchain network includes a first internode including the first node and the second node.

6. The blockchain system according to claim 2, wherein the transaction classifying network classifies transactions transmitted from the clients into a first transaction batch to be transmitted to a first blockchain network, a second transaction batch to be transmitted to a second blockchain network, and a third transaction batch to be transmitted to an internode.

7. The blockchain system according to claim 6, wherein the transaction classifying network classifies the transaction proposal by dividing a period based on a set condition.

8. The blockchain system according to claim 7, wherein the set condition is a set time and a transaction processing capacity of the transaction batch and the transaction classifying system classifies the transaction proposal which is transmitted by a time when any one condition of the set time and the transaction processing capacity is completed.
